(19) United States
(12) Patent Application Publication
(10) Pub. No.: US 2014/0052429 A1
(43) Pub. Date: Feb. 20, 2014

(54) PROACTIVE DATA CENTER COOLING

(71) Applicants: Bhooshan Prafulla Kelkar, Pune (IN); Sandeep Ramesh Patil, Pune (IN)

(72) Inventors: Bhooshan Prafulla Kelkar, Pune (IN); Sandeep Ramesh Patil, Pune (IN)

(73) Assignee: INTERNATIONAL BUSINESS MACHINES CORPORATION, ARMONK, NY (US)

(21) Appl. No.: 13/589,277

(22) Filed: Aug. 20, 2012

(51) Int. Cl. G05D 23/00; G06G 7/62

(52) U.S. Cl. 703/13; 700/300; 700/276

(57) ABSTRACT

A mechanism is provided to optimize cooling of a data center having a plurality of computer systems. A dataset is classified into a plurality of data storage regions hosted by at least one of the plurality of computer systems. A plurality of cooling devices is grouped into groups. Each group of the plurality of cooling devices cools at least one of the plurality of data storage regions. The classified dataset is analyzed to identify one of the plurality of data storage regions having heat-intensive data. An operating parameter is selectively adjusted for one of the group of the plurality of cooling devices that corresponds to cooling the identified one of the plurality of data storage regions having the heat-intensive data.

### BACKGROUND

The disclosure relates generally to cooling systems for data centers, and more specifically to proactive data center cooling.

Businesses have grown increasingly dependent on the processing power of computer systems. Traditionally, as the size and complex nature of a business grows, its computing needs are greatly increased. Many large businesses require a number of sophisticated computers such as servers to provide for their computing needs. These computing needs require fast and continuous operation of all systems that at times have to be in communication with one another.

It is often more convenient to house a variety of computer systems in a common facility known as a data center. Data centers also house associated computer components such as telecommunication and storage systems. Redundant and backup units such as power supplies, data communication connections and environmental and security devices may also be housed in the same location. Because of cost concerns, however, data centers are designed to house a maximum number of units, including the computer systems and their associated components, in a tight foot print. Locating a large number of heat generating systems and components in one location and in close proximity to one another requires the designer of these facilities to address heat dissipation issues.

At the same time, the computer industry trend has been to continuously increase the number of electronic components inside each computer or systems to provide maximum processing power. The ever growing number of heat generating components inside the computer units further exacerbates the heat dissipation issues. These issues if not dealt with adequately can harm the structural and data integrity of the computer system and even the data center as a whole.

A variety of cooling mechanisms are used in data centers to dissipate heat generated by computer systems in the data centers. The cooling mechanisms are also used to ensure that the computer systems operate within safe operating temperatures. The cooling mechanisms heavily impact electric power consumption of the data centers. Consequently, the cooling mechanisms are a significant cost of the data centers. Thus, it is highly desirable to reduce the energy consumption of the cooling equipment or reclaim some of that power to reduce data center operating cost and limit its impact to the environment.

### SUMMARY

In one illustrative embodiment, a method for optimizing cooling of a data center having a plurality of computer systems is provided. The method comprises a processor classifying a dataset into a plurality of data storage regions hosted by at least one of the plurality of computer systems. The method further comprises the processor grouping a plurality of cooling devices. Each group of the plurality of cooling devices cools at least one of the plurality of data storage regions. The method further comprises the processor analyzing the classified dataset to identify one of the plurality of data storage regions having heat-intensive data. The method further comprises the processor selectively adjusting an operating parameter for one of the group of the plurality of cooling devices that corresponds to cooling the identified one of the plurality of data storage regions having the heat-intensive data.

In another illustrative embodiment, a computer program product for optimizing cooling of a data center having a plurality of computer systems is provided. The computer program product comprises one or more computer-readable tangible storage medium and program instructions stored on at least one of the one or more computer-readable tangible storage medium. The computer-readable tangible storage medium comprises program instructions to classify a dataset into a plurality of data storage regions hosted by at least one of the plurality of computer systems. The computer-readable tangible storage medium further comprises program instructions to group a plurality of cooling devices. Each group of the plurality of cooling devices cools at least one of the plurality of data storage regions. The computer-readable tangible storage medium further comprises program instructions to analyze the classified dataset to identify one of the plurality of data storage regions having heat-intensive data. The computer-readable tangible storage medium further comprises program instructions to selectively adjust an operating parameter for at least one of the plurality of cooling devices associated with the group that corresponds to cooling the identified one of the plurality of data storage regions having the heat-intensive data.

In another illustrative embodiment, a computer system for cooling of a data center having a plurality of computer systems is provided. The computer system comprises one or more processors, one or more computer-readable memories, one or more computer-readable tangible storage medium, and program instructions stored on at least one of the one or more storage medium for execution by at least one of the one or more processors via at least one of the one or more memories. The computer-readable tangible storage medium comprises program instructions to classify a dataset into a plurality of data storage regions hosted by at least one of the plurality of computer systems. The computer-readable tangible storage medium further comprises program instructions to group a plurality of cooling devices. Each group of the plurality of cooling devices cools at least one of the plurality of data storage regions. The computer-readable tangible storage medium further comprises program instructions to analyze the classified dataset to identify one of the plurality of data storage regions having heat-intensive data. The computer-readable tangible storage medium further comprises program instructions to selectively adjust an operating parameter for at least one of the plurality of cooling devices associated with the group that corresponds to cooling the identified one of the plurality of data storage regions having the heat-intensive data.

### BRIEF DESCRIPTION OF THE SEVERAL VIEWS OF THE DRAWINGS

FIG. 1 is a block diagram of a sample computer network of data centers in which the present invention can be implemented;

FIG. 2 is a perspective view illustration of a computer housing having a rack frame;

FIG. 3 shows a simplified perspective view of a data center in accordance with an illustrative embodiment;

FIG. 4 is a flowchart of a method for managing a dataset performed by the dataset manager program in accordance with an illustrative embodiment;

FIG. 5 is a flowchart of a method for analyzing a dataset performed by the dataset analyzer program in accordance with an illustrative embodiment;

FIG. 6 is a flowchart of a method for controlling an array of cooling devices performed by the cooling controller program in accordance with an illustrative embodiment; and

FIG. 7 is a block diagram of internal and external components of each of the computers of FIG. 1.

### DETAILED DESCRIPTION

Embodiments of the present invention will now be described with reference to the figures. The size of computer systems continues getting smaller, while the storage capacity of the computer systems and the computational power of processors increase. This results in an increase in computational power, per volume, of data centers, and results in an increase in power density. This, in turn, results in higher heat production in the data centers. Cooling mechanisms used to cool the data centers also consume power and contribute to a further increase in power density. Existing cooling mechanisms rely on cooling appliances with a variety of cooling characteristics (for example, different ratings, motor size, cooling efficiency, power consumption, etc.) to cool the computer systems. The power consumed by the cooling appliances is dependent on their cooling characteristics. For example, a fan with 1 kW-0.4 rating consumes less power but generates less cool air, while a fan with 100 kW-0.93 rating consumes more power but also generates more air to act as a coolant. In one aspect, it is recognized that a set of desired operating parameters may be determined for a cooling device by employing concepts of thermodynamics and heat transfer. In some embodiments, by so determining the set of desired operating parameters, any of the operating parameters for a given cooling device may be dynamically adjusted based on a data center's environment, which is at least defined by characteristics of the various cooling devices in the data center and an analysis of the heat generating information about the monitored computer system.

Adaptive adjustment of operating parameters leads to intelligent utilization of cooling devices to cool a plurality of computer systems hosting a dataset in a data center, which can lead to reduced power consumption. Dataset analysis determines whether any subset of the entire data center dataset is a “heat-intensive dataset.” To determine whether a dataset is a heat-intensive dataset, dynamic dataset analysis takes into account operations on the entire dataset and attributes of the host physical storage device to determine if a given dataset corresponds to heat generation beyond a heat rise threshold. Dynamically adjusting operating parameters of cooling devices can ensure that highest rated cooling devices are used to cool datasets that correspond to a highest heat generation, and that lower rated cooling devices are used to cool datasets that cause comparatively less heat generation. In other words, dynamic adjustment of operating parameters of cooling devices based on expected heat dissipation of a data center can ensure that appropriate cooling devices are used to cool appropriate datasets (i.e., computer systems that host the datasets). Adapting operational parameters to the expected data center environment can reduce hot and cold spots in the data center and can also preclude changing the data center environment (e.g. physically moving the computer systems or cooling devices) or preclude categorizing specific computer systems for specific types of data. Maintaining optimal cooling of the plurality of computer systems in a data center can also help reduce the data center costs.

As used herein, “data center” includes any facility or portion of a facility in which computer operations are carried out. A data center may include servers dedicated to specific functions or serving multiple functions. Examples of computer operations include information processing, communications, simulations, and operational control.

As used herein, “computer room” means a room of a building in which computer systems, such as rack-mounted servers, are operated.

As used herein, “computer system” includes any of various computer systems or components thereof. One example of a computer system is a rack-mounted server. As used herein, the term computer is not limited to just those integrated circuits referred to in the art as a computer, but broadly refers to a processor, a server, a microcontroller, a microcomputer, a programmable logic controller (PLC), an application specific integrated circuit, and other programmable circuits, and these terms are used interchangeably herein.

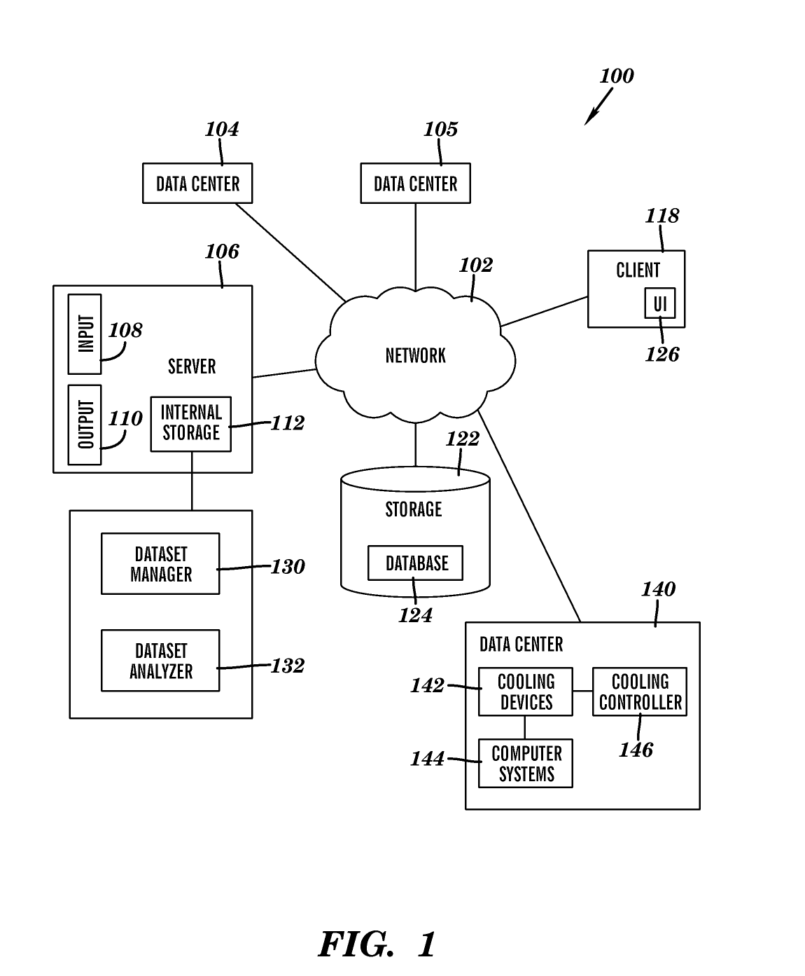

FIG. 1 is a conceptual block diagram of a sample computer networked environment 100 of data centers in which the present invention can be implemented. FIG. 1 is an illustration of one implementation and is not intended to imply any limitation with regard to the environments in which different embodiments may be implemented. Many modifications to the depicted environments may be made.

In one embodiment network 102 can be the Internet which uses the TCP/IP suite of protocols. Network 102 may also comprise a number of different types of networks, such as an intranet, a local area network (LAN), a wide area network (WAN), wireless local area network (WLAN), synchronous optical network (SONET), and the like.

Network 102 provides communication links between various devices, computers, and data centers. Network 102 may include connections, such as wire, wireless communication links, fiber optic cables, or any other connection technology known in the art. Network 102 may include additional server computers, client computers, displays and other devices not shown.

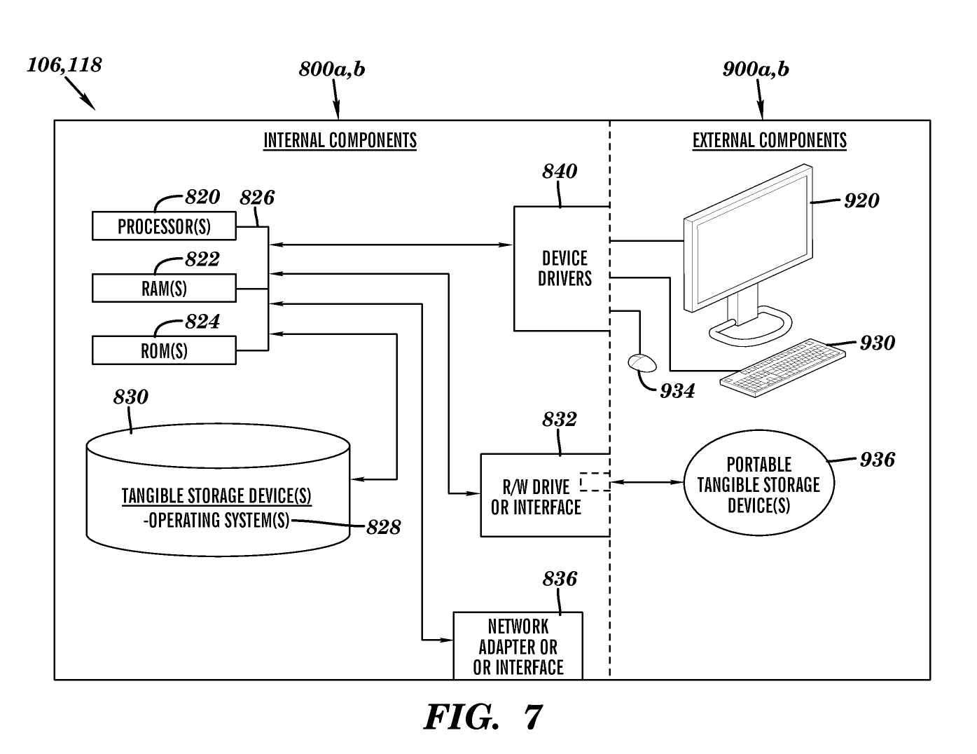

The exemplary networked environment 100 may include data centers 104, 105, and 140, coupled to client computer 118, server computer 106 and storage unit 122 via network 102. As will be discussed with reference to FIG. 7, server computer 106 includes internal components 800a and external components 900a and client computer 118 includes internal components 800b and external components 900b. For simplicity purposes, only three data centers 104, 105 and 140 are shown in FIG. 1, although in other embodiments, networked environment 100 can include additional data centers. Alternative embodiments of the present invention can include only one data center 140.

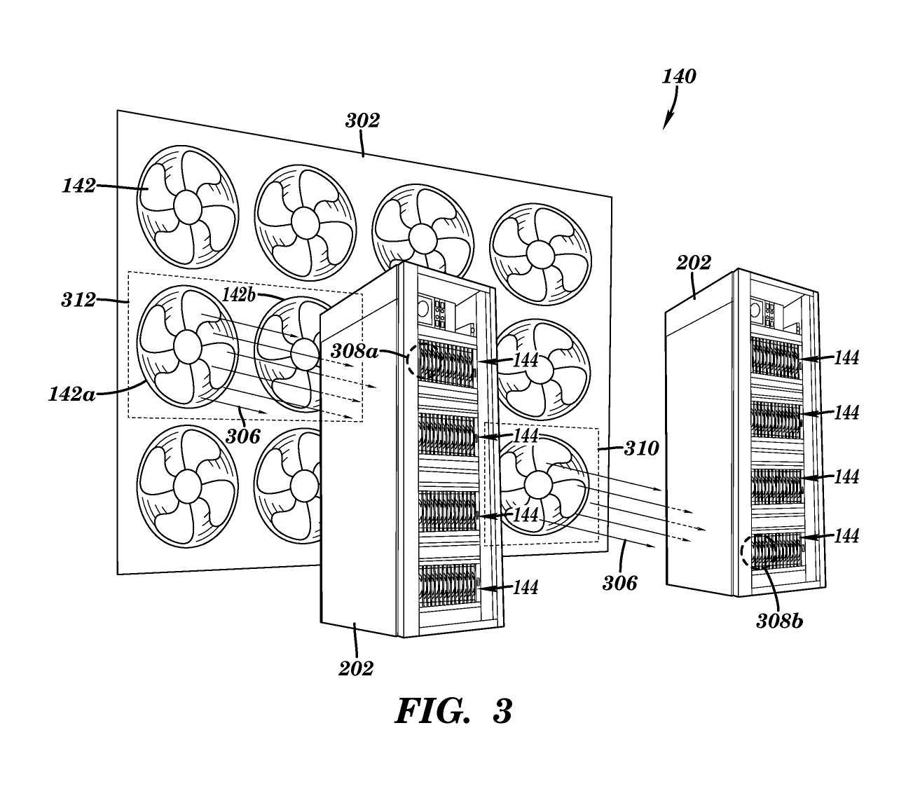

The exemplary data center 140 comprises a plurality of computer systems 144, a plurality of cooling devices 142, and a cooling controller program 146. Cooling devices 142 may be strategically placed throughout data center 140 so that cooling devices 142 cool the computer systems 144 (as illustrated in FIG. 3). In an embodiment of the present invention, cooling controller program 146 may be configured to monitor and control operating parameters of cooling devices 142. Cooling controller program 146 may also maintain information about physical locations and cooling characteristics of cooling devices 142.

Server computer 106 connects to network 102. Server computer 106 may be configured to communicate with data centers 104, 105, and 140, for example, through cooling controller programs, such as the cooling controller program 146 in data center 140. Server computer 106 may be a workstation, a mainframe computer, a personal computer, and the like. In one embodiment, server computer 106 runs dataset manager program 130 and dataset analyzer program 132. Dataset manager program 130 may be configured to manage information relating to the location of data in the monitored computer systems 144. In an embodiment, dataset manager program 130 may also be configured to maintain associations between particular locations of data hosted by computer systems 144 and dedicated sets of cooling devices 142 responsible for cooling off the heat dissipated by the computer systems 144. Dataset analyzer program 132 may be configured to identify datasets that result in generation of at least a threshold amount of heat. Dataset analyzer program 132 may determine the heat-intensive datasets based on identifying frequently accessed datasets, determining a power consumption/heat generation associated with accessed datasets, and accordingly identifying datasets that result in a generation of at least the threshold amount of heat. Dataset analyzer program 132 may also be configured to determine a computer system (for example, a physical storage device) that hosts the heat-intensive dataset.

Server computer 106 may service requests by client 118 to dataset manager program 130 and dataset analyzer program 132. In another embodiment, server computer 106 acts as a server to client 118 running dataset manager program 130 and responds to requests from dataset manager program 130 running on client 318 to dataset analyzer program 132 running on server 106. Server computer 106 may contain an input device 108 and an output device 110.

Dataset manager program 130, dataset analyzer program 132, and cooling controller program 146 may comprise program instructions stored on one or more computer-readable tangible storage devices, which may include internal storage 112 on server computer 106. Cooling controller program 146 may be downloaded to a dedicated computer system or other device for use. Data gathered, generated, and maintained for use by dataset manager program 130, dataset analyzer program 132, and cooling controller program 146 may be kept in internal storage 112 of server computer 106 or in one or more databases 124 of storage unit 122.

Client computer 118 also connects to network 102. Client computer 118 may be, for example, a mobile device, telephone, television receiver, cell phone, personal digital assistant, netbook, laptop computer, tablet computer, desktop computer, and/or any type of computing devices capable of executing software in accordance with the embodiments described herein. Client computer 118 may contain user interface (UI) 126. UI 126 can be, for example, graphical user interface (GUI) or web user interfaces (WUI).

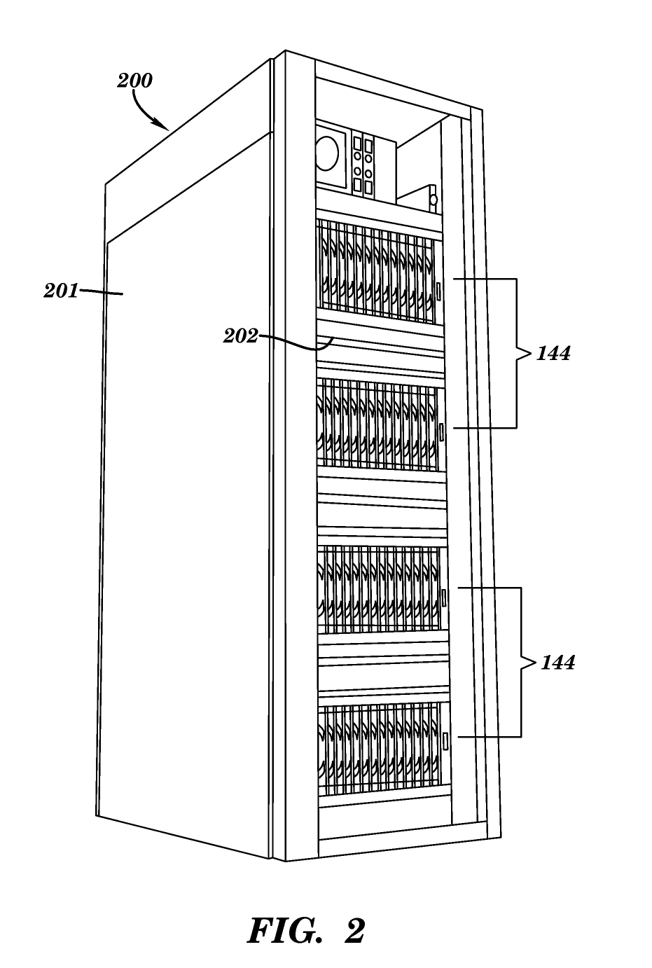

Turning now to FIG. 2, FIG. 2 is a perspective view illustration of a computer environment comprising a housing 200, having a frame 202, preferably with a rack or cage like structures as shown. The housing 200 can also incorporate full or partial doors or covers such as referenced by numeral 201.

It should be noted that as used herein, the term computer or electronic rack 202, hereinafter will be used for ease of reference but can be construed to include any housing, frame, rack, compartment, blade server system or other structural arrangements including any that may incorporate doors and/or covers. In addition, the computer rack 202 can be either a stand alone computer processor or a sophisticated system, having high, mid or low end processing capability. The electronic rack 202 may also comprise a stack of electronic system chassis or multi-blade center systems 144, as well as supporting power supplies, networking equipment and other similar and necessary components, not individually illustrated.

In a typical data center, a plurality of such computer racks 202 are disposed next to one another in as tight of a fit as allowable by the rack design and needs of the electronic components inside each system. With reference to FIG. 3, there is shown a simplified perspective view of an exemplary data center 140.

The data center 140 depicted in FIG. 3 represents a generalized illustration and other components may be added or existing components may be removed or modified without departing from the scope of the invention. For example, data center 140 may include any number of racks and various other devices known to be housed in data centers. Thus, although the data center 140 is illustrated as containing one row of computer racks 202 and a single array 302 of cooling devices 142, it should be understood that data center 140 may include any number of racks, for instance computer racks 202 and arrays 302 of cooling devices 142 without departing from the scope of the invention. The depiction of 1 row of computer racks 202 and one array 302 of cooling devices 142 is thus for illustrative and simplicity of description purposes only and is not intended to limit the invention in any respect.

The data center 140 may have a plurality of computer racks 202, for instance, electronic cabinets, aligned in substantially parallel rows. The computer racks 202 are illustrated as having open front sides such that the computer systems 144 housed therein are visible. It should, however, be understood that embodiments of the invention may be practiced with racks having panels that cover the front sides of the computer racks 202 without departing from a scope of the invention.

The computer racks 202 are generally configured to house a plurality of computer systems 144 designed to perform various operations, for instance, computing, switching, routing, displaying, and the like. These computer systems 144 may comprise subsystems (not shown), for example, high-speed video cards, memories, semiconductor devices, and the like to perform these functions. In the performance of these electronic functions, the computer systems 144, and therefore the subsystems, dissipate relatively large amounts of heat. Because the computer racks 202 may include upwards of forty (40) or more subsystems, they may transfer substantially large amounts of heat.

It should be understood that the computer racks 202 may include any number of computer systems, for instance forty or more components of computer systems or two hundred or more blade systems 144, without departing from the scope of the invention. In addition, although the computer racks 202 are illustrated as containing computer systems 144 throughout the heights of the computer racks 202, it should be understood that some of the computer racks 202 may include slots or areas that do not include computer systems 144 without departing from the scope of the invention.

The array 302 of cooling devices 142 may blow cool air, for example at a regulated temperature, to cool off the dissipated heat being generated by computer systems 144 housed by computer racks 202. Cooling devices 142 may be configured to cool, vent, remove humidity, and/or provide air circulation to computer systems 144 of computer racks 202. In one embodiment, array 302 may comprise an array of fans 142 arranged in a matrix form. Each cooling device 142 may be any electro-mechanical fan used for cooling computer systems 144 housed by computer racks 202. In certain embodiments, cooling devices 142 may draw cool air from the outside or expel warm air from one or more particular component of computer racks 202. In some embodiments, a plurality of cooling devices 142 may form a redundant cooling fan array. A redundant cooling fan array may permit continued cooling of computer racks 202 in the event that one or more of cooling fans 142 fails.

In some embodiments, cooling device 142 may be a computer room air conditioning unit (CRAC) configured to intake air from the surroundings through an intake and cool the airflow for output of a cooling airflow with a preconfigured temperature through an exhaust. The output air from cooling device 142 may be directed to computer racks 202, indicated by arrows 306 in FIG. 3.

In the same or alternative embodiments, cooling device 142 may be a computer room air handling unit (CRAH) using circulating chilled water and a chiller to cool air emitted from computer racks 202. It is noted that other air handling units, including, but not limited to, in space unit (ISU), hot and cold aisle containment arrangements, and other cooling units may be used in various embodiments of the present invention.

In the embodiment illustrated in FIG. 3, array 302 may be communicatively coupled to cooling controller program 146 (as shown in FIG. 1) to allow the cooling controller program 146 to control the operation of the cooling devices 142, which will be discussed in greater detail below. Cooling controller program 146 may run in any of various types of computer systems described herein, including desktop computers or workstations, embedded microcontrollers, electronic control units, programmable logic devices, mainframe computers, and the like.

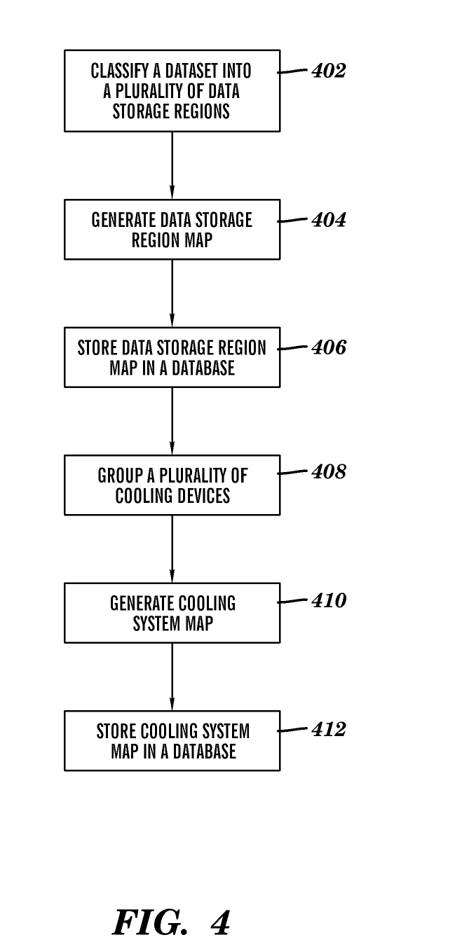

FIG. 4 is a flowchart of a method for managing a dataset performed by the dataset manager program in accordance with an illustrative embodiment.

The following provides a high level overview of data storage technology. Logical storage relates to data presentation and management in the exemplary embodiments as it ultimately appears to the application data and/or file system contained in various computer systems 144 housed by computer racks 202. The logical storage may be structured and organized according to the operating system's convention, logical block numbers, or other means appropriate to the operating system or other specialized application. The logical storage represents a conventional scheme, such as logically mapping each addressable block by contiguous monotonically increasing identifiers. Alternatively, logical storage arrangements could rely on combinations of drive/platter/head/cylinder, or other scheme of physical origins, to identify data locations. There may be multiple levels of logical storage mapping, though the term is broadly used herein and implies a drive geometry or addressing mechanism visible to the operating system or other applications, such as dataset manager program 130 that makes use of the mapped logical storage described below. As used herein “entire dataset” includes managed space (mapped storage) that relates to the totality of physical storage which is provided as logical storage to applications or operating systems and typically includes a sequence of one or more zones, each a grouping of one or more distinct storage media or partitions therein, such as independent drives, partitions or RAID arrays, which are then aggregated to form contiguous logical storage for applications.

Data is typically stored in specialized physical data storage devices, though it may be temporarily maintained in random-access memory cache and ultimately on physical moving media, such as a conventional magnetic hard disk, optical disk, or similar electromechanical recording mechanism. A temporary random-access memory cache may be used to enhance operations by keeping frequently or recently accessed data in rapidly accessible memory. The same cache-like management techniques may be used to maintain update information between the time the update is received and when it is ultimately processed.

A Redundant Array of Independent Disks (RAID) is a storage arrangement of which there are many variations. Multiple drives are logically coupled to provide a larger composite storage entity that exhibits better storage capacity, performance and/or reliability than a single drive or a group of unrelated drives would provide. RAID is a standard term in the storage industry and its use here refers to the spectrum of capabilities unless otherwise stated. The RAID array(s), regardless of their actual configuration, provide composite storage areas, from the perspective of various embodiments of the invention, which may be treated as one or more data storage regions for purposes of the invention. The various embodiments can utilize the storage provided by one or more RAID arrays, alone or in combination with other storage media.

A volume or logical volume, or logical region of storage is typically made available to an operating system, through its volume mounting or similar mechanisms, or to a particular set of applications, such that the implementation of the dynamic reorganization is transparent to the operating system or applications that make use of the logical volume. A single logical volume is typically maintained in one or more zones, subject to the dynamic reorganization and related methods, which are dedicated to the particular volume's needs or shared with other volumes, as determined by the particular embodiment or its configuration. The concept of volume is also present at a lower level, implemented by disk array technologies, such as RAID, that provide the physical zones in which actual data is stored. The lower level concept is usually referred to herein as physical storage or zones, which are ultimately referring to physical storage.

A data storage region is a convenient term to refer to a separately and independently accessible region of storage space. Multiple independent physical storage devices, or partitions therein, could each be designated as separate data storage regions, multiple RAID arrays could each be designated as a data storage region, and the like. A data storage region is a configured storage space that is meaningful to the exemplary embodiments for dataset analysis purposes. It is desirable, though not essential, that no access to one data storage region should significantly interfere or limit concurrent access to other data storage regions. All data storage regions used as part of an entire dataset (managed space) may be required to have certain common properties determined by the particular embodiment.

A data storage region block is a single logical block of storage within a data storage region at the smallest addressable level. For purposes of the exemplary embodiments, each data storage region may have a set of sequentially numbered data storage region blocks. All blocks in a particular data storage region may be the same size, typically, but not necessarily, 512 to 4096 bytes and normally a power of 2.

Referring back to FIG. 4, at 402 dataset manager program 130 may classify an entire dataset (the totality of physical storage in all computer systems 144 within the data center 140) into a plurality of data storage regions. A data storage region may have properties as configured for use by the exemplary embodiments. For example, each data storage region may have a corresponding unique identification number. The data storage region properties may include information on the data storage region block size, the data storage region cluster size, the degree and patterns of independence of numerically adjacent storage clusters, and so on. Dataset manager program 130 may store data storage region properties in conjunction with overall dataset configuration information, independently, or in any practical combination. In an embodiment, dataset manager program 130 may replicate all data storage region configuration, for example, in a reserved area in each data storage region.

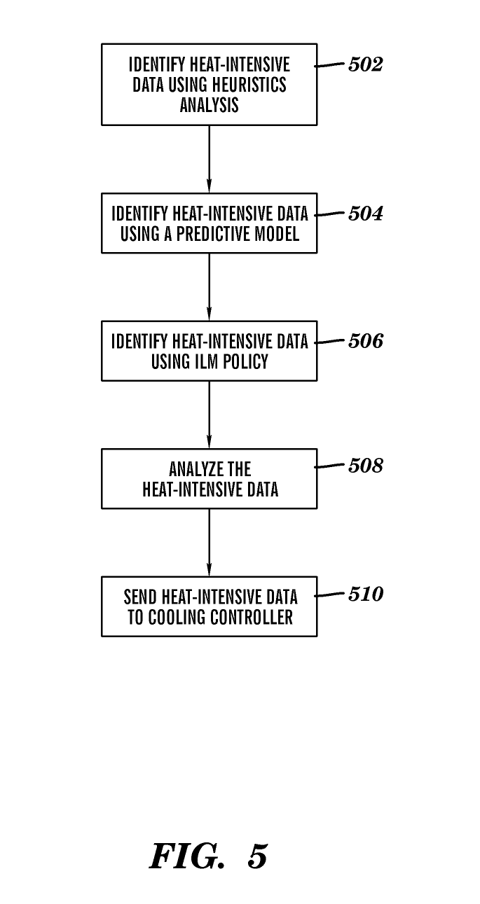

At 404, dataset manager program 130 may generate a data storage region map. In an embodiment, the data storage region map may be implemented as a table that provides a linkage between the data storage region identifiers and the physical data storage location identifiers. The physical data storage units may be blocks, clusters, and the like. Dataset manager program 130 may use the data storage region map to maintain the relationship between logical data storage regions classified at 402 and the physical location(s) in which the corresponding data storage region is stored. In an embodiment the data storage region map may include information representing the data storage region id—physical location id tuples. At 406, dataset manager program 130 may store the data storage region map in one or more databases 124 of storage unit 122. The data store region map stored in the database 124 may be used by dataset analyzer 132 to analyze the dataset, as described below in conjunction with FIG. 5. In an embodiment, storage unit 122 may comprise a cloud storage system.

At 408, dataset manager program 130 may group the plurality of cooling devices 142 into groups based on the data storage regions map and physical location of the plurality of cooling devices 142, so that each group may be responsible to cool off the heat dissipated by a corresponding data storage region. In an embodiment, dataset manager program 130 may generate a unique identification number for each of the groups identified at 408.

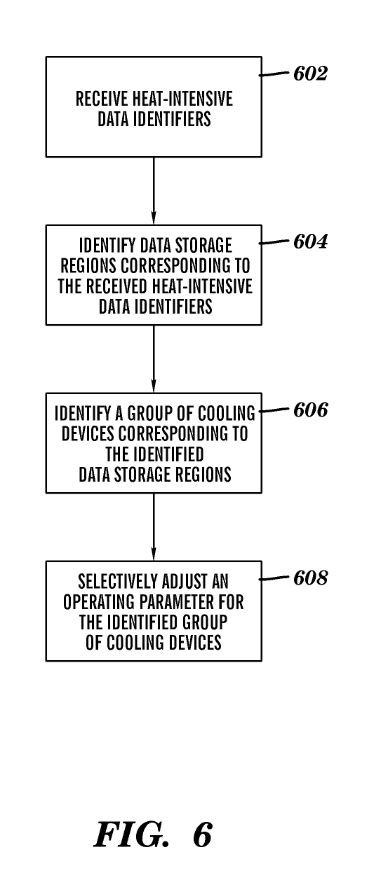

At 410, dataset manager program 130 may generate a cooling system map. In an embodiment, the cooling system map may be implemented as a table that provides a mapping between each group of cooling devices and one or more corresponding data storage regions. For example, referring back to FIG. 3, group A 312 may include two cooling devices 142a and 142b. Dataset manager program 130 may choose to associate group A 312 with, for example, data storage regions (referenced as numeral 308a in FIG. 3). In other words, group A 312 may be responsible to cool off the heat dissipated by the data storage regions 308a. In accordance with the illustrated embodiment, dataset manager program 130 may generate an entry in the cooling system map correlating group A 312 with the identification numbers for data storage regions 308a. In an embodiment, the cooling system map may include information representing the data storage region id—group id tuples. Similarly, for example, group B 310 may be associated with the data storage region 308b (as illustrated in FIG. 3). At 412, dataset manager program 130 may store the cooling system map in one or more databases 124 of storage unit 122. The cooling system map stored in the database 124 may be used by cooling controller program 146 to selectively adjust an operating parameter for any given group of cooling devices 142, as described below in conjunction with FIG. 6. In an embodiment, storage unit 122 may comprise a cloud storage system.

FIG. 5 is a flowchart of a method for analyzing a dataset performed by the dataset analyzer program in accordance with an illustrative embodiment. In at least one embodiment, dataset analyzer program 132 may use the data storage information described above in a cumulative fashion to determine the heat-intensive dataset sets. At 502, dataset analyzer program 132 may identify one or more heat-intensive datasets using heuristics analysis. For example, dataset analyzer program 132 may use a set of heuristics to identify data that is likely to be requested in the next predetermined interval of time. In an embodiment, heat-intensive dataset determination may be based on a heuristic determination of one or more of or a combination of one or more of: the most recently accessed data storage region, most recently written to data storage region, most recently read from data storage region, most often accessed data storage region, most often read from data storage region, most often written to data storage region, the data storage region accessed by most processes, the data storage region written to by most processes, the data storage region read from by most processes, the data storage region accessed by most processes, the data storage region read most by a specific process or processes, the data storage region written to most by a specific user or users, and the like. Dataset analyzer program 132 may rank data storage regions of the entire dataset according to a usage scale. In addition, dataset analyzer program 132 may determine power consumption/heat generation associated with accessing each data storage region, and accordingly dataset analyzer program 132 may identify the data storage regions that result in a generation of at least a predetermined threshold amount of heat. In another embodiment, dataset analyzer program 132 may identify a heat-intensive dataset based on at least one characteristic of the dataset and based on historic data. It should be noted that as used herein the historic data may indicate past data access patterns corresponding to the at least one characteristic of the dataset. For example, dataset analyzer program 132 may determine that data storage regions storing data which is classified as metadata represent most often accessed data storage regions. Therefore, dataset analyzer program 132 may determine that future access to these data storage regions may result in heat dissipations that are above the predetermined threshold. In another example, dataset analyzer program 132 may identify data storage regions containing data which relates to index of at least one database table as heat-intensive datasets because such data storage regions are highly accessed regions resulting in higher heat dissipation.

Referring back to FIG. 5, at 504 dataset analyzer program 132 may identify one or more heat-intensive datasets using a predictive model. A variety of predictive analytics, data mining models technologies, data mining methodologies, and so forth can be utilized to build the predictive model. Training data can be utilized to build a model that learns, for example, patterns of the data access associated with the business value of the data, which may be influenced by various business parameters. Various algorithms, methods, and/or techniques can be employed to build the predictive model and all such algorithms, methods, and/or techniques are intended to fall within the scope of this detailed description. In an embodiment, dataset analyzer program 132, when trying to identify one or more heat-intensive datasets, may generate the predictive model capable of predicting a data access pattern related to a business behavioral pattern. Dataset analyzer program 132 may utilize a plurality of predictive modeling techniques to predict highly accessed data based on various business parameters. The predictive modeling techniques may include, but are not limited to, decision trees, logistic regression classification, survival analysis, outlier detection, trend analysis, correlation analysis and factor and cluster analysis. A decision tree is a predictive modeling technique that predicts outcomes in a dataset based on searching and discovering trends, patterns and relationships in the dataset. Similarly, logistic regression classifiers refer to predictive modeling techniques that perform predictions by analyzing relationships between one or more parameters (for example, business parameters) of interest (dependent variables/response variables) and a set of predictor variables (independent variables). Analysis can be performed utilizing one or more tools such as SPSS Statistics and SPSS Modeler, offered by International Business Machines Corporation, Armonk, N.Y., and the like.

At 506, dataset analyzer program 132 may assess the entire dataset to identify the heat-intensive data based on an information lifecycle management (ILM) data storage policy. ILM may involve the assessment of data “value” and the corresponding assignment of such data to tiered storage. In an embodiment, dataset analyzer program 132 may utilize various data storage policies which classify data in the dataset according to defined parameters, and which take into account differentiating factors such as access speed requirements, anticipated access frequency, anticipated concurrency level, and the like. Such data storage policies typically place important data, for example data that is frequently accessed, in high tier storage that provides easy and quick retrieval, while other information may be placed in slower, or low tier storage. In an embodiment, dataset analyzer program 132 may identify data storage regions associated with high tier storage as heat-intensive data. In another embodiment, dataset analyzer program 132 may determine what data access may be anticipated in the future based upon current data access trends.

It should be noted that any of the 502, 504, and 506 may be optional and dataset analyzer program 132 may execute 502,504, and 506 in any order. At 508, dataset analyzer program 132 may analyze results generated at 502, 504, and 506. For example, dataset analyzer program 132 may combine all identified heat-intensive data storage regions into one or more groups. In addition, dataset analyzer program 132 may remove any redundant data storage regions from the combined results.

At 510, dataset analyzer program 132 may transmit one or more heat-intensive data storage region identifiers to the cooling controller program 146.

FIG. 6 is a flowchart of a method for controlling an array of cooling devices performed by the cooling controller program in accordance with an illustrative embodiment. At 602, cooling controller program 146 may receive one or more heat-intensive data storage region identifiers from, for example, dataset analyzer program 132. At 606, cooling controller program 146 may identify one or more groups of cooling devices 142 responsible for cooling off one or more heat-intensive data storage regions received at 602 using, for example, cooling system map stored in the database 124. At 608, cooling controller program 146 may selectively adjust at least one operating parameter for the one or more groups identified at 606. For example, if the array of cooling devices 142 is implemented as an array of electro-mechanical fans such fans may be provided with motors and/or variable-pitch blades. In this example, control of the speed of operation of fan 142 may regulate the flow of the cold air toward the corresponding heat-intensive data storage region. For illustrative purposes, in one embodiment, dataset analyzer program 132 identified data storage region referred to by numeral 308a in FIG. 3 as heat-intensive and that group A 312 is linked to that data storage region in the cooling system map. In an embodiment, cooling controller program 146 may increase the speed of rotation and/or a direction of rotation for all fans in the group A only. Similarly, in an embodiment where cooling device 142 is implemented as CRAC unit, cooling controller program 146 may be configured to adjust the flow of cold air through each CRAC unit in the corresponding group of CRAC units. In various embodiments, cooling controller program may also be configured to control direction of air flow, temperature of cold air, and the like. Therefore, cooling controller program 146 may advantageously selectively adjust at least one operating parameter in a particular group of cooling devices 142 in a proactive manner in response to predictive analysis performed by dataset analyzer program 132.

FIG. 7 is a block diagram of internal and external components of each of the computers of FIG. 1. Computers 106 and 118 include respective sets of internal components 800a, b and external components 900a, b. Each of the sets of internal components 800a, b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828, dataset manager program 130, dataset analyzer program 132 and cooling controller program 146 are stored on one or more of the computer-readable tangible storage devices 830 for execution by one or more of the processors 820 via one or more of the RAMs 822 (which typically include cache memory). In the embodiment illustrated in FIG. 7, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a,b also includes a R/W drive or interface 832 to read from and write to one or more portable computer-readable tangible storage devices 936 such as a CD-ROM, DVD, memory stick, magnetic tape, magnetic disk, optical disk or semiconductor storage device. Dataset manager program 130, dataset analyzer program 132, and cooling controller program 146 can be stored on one or more of the portable computer-readable tangible storage devices 936, read via R/W drive or interface 832 and loaded into one or more computer-readable tangible storage devices 830.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Referring back to FIG. 7, each set of internal components 800a,b also includes a network adapter or interface 836 such as a TCP/IP adapter card. Dataset manager program 130 and dataset analyzer program 132 can be downloaded to sever computer 106 from an external computer via a network (for example, the Internet, a local area network or other, wide area network) and network adapter or interface 836. From the network adapter or interface 836, dataset manager program 130 and dataset analyzer program 132 are loaded into one or more computer-readable tangible storage devices 830. The network may comprise copper wires, optical fibers, wireless transmission, routers, firewalls, switches, gateway computers and/or edge servers.

Each of the sets of external components 900a,b include a computer display monitor 920, a keyboard 930, and a computer mouse 934. Each set of internal components 800a,b also include device drivers 840 to interface to computer display monitor 920, keyboard 930 and computer mouse 934. The device drivers 840, R/W drive or interface 832 and network adapter or interface 836 comprise hardware and software (stored in one or more computer-readable tangible storage devices 830 and/or one or more computer-readable ROMs 824).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for optimizing cooling of a data center having a plurality of computer systems, the method comprising:
a processor classifying a dataset into a plurality of data storage regions hosted by at least one of the plurality of computer systems;
the processor grouping a plurality of cooling devices, wherein each group of the plurality of cooling devices cools at least one of the plurality of data storage regions;
the processor analyzing the classified dataset to identify one of the plurality of data storage regions having heat-intensive data; and
the processor selectively adjusting an operating parameter for at least one of the plurality of cooling devices associated with the group that corresponds to cooling the identified one of the plurality of data storage regions having the heat-intensive data.

2. The method of claim 1, wherein the processor analyzing the classified dataset comprises the processor assessing the dataset to identify one of the plurality of data storage regions having the heat-intensive data based on a set of heuristics.

3. The method of claim 2, wherein at least one heuristic is based on at least one characteristic of the dataset and wherein the at least one heuristic is based on historic data, wherein the historic data indicates past data access patterns corresponding to the at least one characteristic of the dataset.

4. The method of claim 1, wherein the processor analyzing the dataset comprises the processor assessing the dataset to identify one of the plurality of data storage regions having the heat-intensive data based on a predictive model.

5. The method of claim 4, wherein the predictive model comprises at least one predictive model operable to predict a data access pattern related to a business behavioral pattern.

6. The method of claim 1, wherein the processor analyzing the dataset comprises the processor assessing the dataset to identify one of the plurality of data storage regions having the heat-intensive data based on an information lifecycle management (ILM) data storage policy.

7. The method of claim 1, wherein the plurality of cooling devices comprises a plurality of fans.

8. The method of claim 7, wherein the operating parameter for each fan of the group of the plurality of fans comprises at least one of: a speed of rotation for the fan, a direction of rotation for the fan.

9. The method of claim 1, wherein the plurality of cooling devices comprises a plurality of a computer room air conditioning (CRAC) units.

10. The method of claim 9, wherein the operating parameter for each CRAC unit of the group of the plurality of CRAC units comprises at least one of: an air flow rate generated by the CRAC unit, a temperature of air flow generated by the CRAC unit.

11. A computer program product for optimizing cooling of a data center having a plurality of computer systems, the computer program product comprising one or more computer-readable tangible storage medium and program instructions stored on at least one of the one or more computer-readable tangible storage medium, the computer-readable tangible storage medium comprising:
program instructions to classify a dataset into a plurality of data storage regions hosted by at least one of the plurality of computer systems;
program instructions to group a plurality of cooling devices, wherein each group of the plurality of cooling devices cools at least one of the plurality of data storage regions;
program instructions to analyze the classified dataset to identify one of the plurality of data storage regions having heat-intensive data; and
program instructions to selectively adjust an operating parameter for at least one of the plurality of cooling devices associated with the group that corresponds to cooling the identified one of the plurality of data storage regions having the heat-intensive data.

12. The computer program product of claim 11, wherein the program instructions to analyze the dataset further comprise program instructions to assess the dataset to identify one of the plurality of data storage regions having the heat-intensive data based on a set of heuristics.

13. The computer program product of claim 12, wherein at least one heuristic is based on at least one characteristic of the dataset and wherein the at least one heuristic is based on historic data, wherein the historic data indicates past data access patterns corresponding to the at least one characteristic of the dataset.

14. The computer program product of claim 11, wherein the program instructions to analyze the dataset further comprise program instructions to assess the dataset to identify one of the plurality of data storage regions having the heat-intensive data based on a predictive model.

15. The computer program product of claim 14, wherein the predictive model comprises at least one predictive model operable to predict a data access pattern related to a business behavioral pattern.

16. The computer program product of claim 11, wherein the program instructions to analyze the dataset further comprise program instructions to assess the dataset to identify one of the plurality of data storage regions having the heat-intensive data based on an information lifecycle management (ILM) data storage policy.

17. The computer program product of claim 11, wherein the plurality of cooling devices comprises a plurality of fans.

18. A computer system for optimizing cooling of a data center having a plurality of computer systems, the computer system comprising one or more processors, one or more computer-readable memories, one or more computer-readable tangible storage medium, and program instructions stored on at least one of the one or more storage medium for execution by at least one of the one or more processors via at least one of the one or more memories, the computer-readable tangible storage medium comprising:
program instructions to classify a dataset into a plurality of data storage regions hosted by at least one of the plurality of computer systems;
program instructions to group a plurality of cooling devices, wherein each group of the plurality of cooling devices cools at least one of the plurality of data storage regions;
program instructions to analyze the classified dataset to identify one of the plurality of data storage regions having heat-intensive data; and
program instructions to selectively adjust an operating parameter for at least one of the plurality of cooling devices associated with the group that corresponds to cooling the identified one of the plurality of data storage regions having the heat-intensive data.

19. The computer system of claim 18, wherein the program instructions to analyze the dataset further comprise program instructions to assess the dataset to identify one of the plurality of data storage regions having the heat-intensive data based on a set of heuristics.

20. The computer system of claim 18, wherein the program instructions to analyze the dataset further comprise program instructions to assess the dataset to identify one of the plurality of data storage regions having the heat-intensive data based on a predictive model.
